(19) United States
(12) Patent Application Publication
(10) Pub. No.: US 2009/0180721 A1
(43) Pub. Date: Jul. 16, 2009

(54) Encoding Bearing Device and Rotating Machine

(76) Inventors: Stellario Barbera, Turin (IT); Jean-Luc Gardelle, Luynes (FR); Armel-Louis Doyer, Savonnieres (FR); Francesco Gallucci, Nichelino (IT)

Correspondence Address: MEYERTONS, HOOD, KIVLIN, KOWERT & GOETZEL, P.C., P.O. BOX 398, AUSTIN, TX, 78767-0398, US

(21) Appl. No.: 11/884,220

(22) PCT Filed: Feb. 15, 2006
(86) PCT No.: PCT/FR06/00349

§ 371 Date: Feb. 11, 2008

(30) Foreign Application Priority Data
Feb. 15, 2005 (IT) TO2005A0000088

(51) Int. Cl. F16C 41/00

(52) U.S. Cl. 384/448

(57) ABSTRACT

A rolling bearing device comprising two races 10, 11 able to rotate relative to one another and at least one seal 13 attached to one of the races and provided with an active portion 16 designed to interact with a sensor element to detect a parameter of rotation of the active portion, characterized in that it comprises, at least on one side of the rolling bearing, a groove 20 made in the outer race 10 and a groove 21 made in the inner race 11, said grooves being substantially coplanar, the seal 13 being mounted in one of the grooves of one of the races and interacting with at least a portion of the other groove of the other race in order to provide a dynamic seal.

The present invention relates to a rolling bearing device fitted with an integrated encoder for the detection of the relative rotation between the races of the rolling bearing. It is therefore possible to detect a parameter of rotation such as the angular speed, the movement, the acceleration of a rotating element fixedly attached to the rotating race.

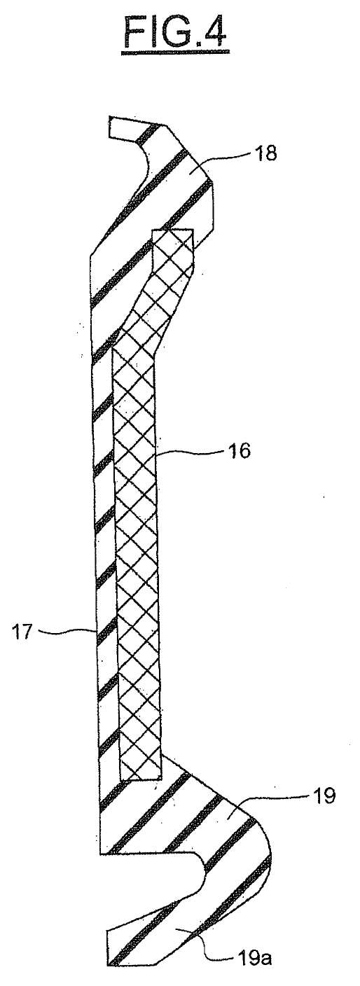

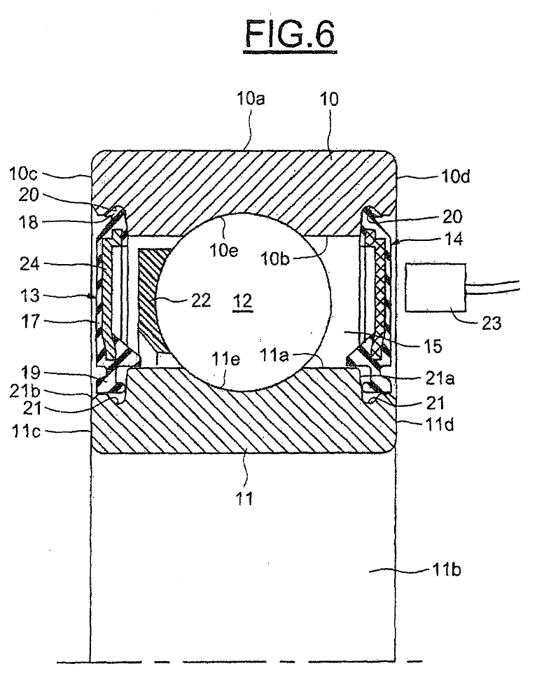

Document EP 0 890 753 shows, in FIG. 4, a rolling bearing whose inner race is fitted with a target seal mounted in a groove made on the inner race. The material used to produce the active portion of the magnetic encoding ring is an elastomer filled with ferrite and cannot provide an effective dynamic seal with the outer race. Specifically, an elastoferrite is a relatively rigid and abrasive material, not very suitable for providing a really effective friction seal, for example between a seal lip and its bearing surface, as is the case in FIG. 6. It is therefore necessary to add an additional seal or to use a bi-material seal in order to ensure an effective seal.

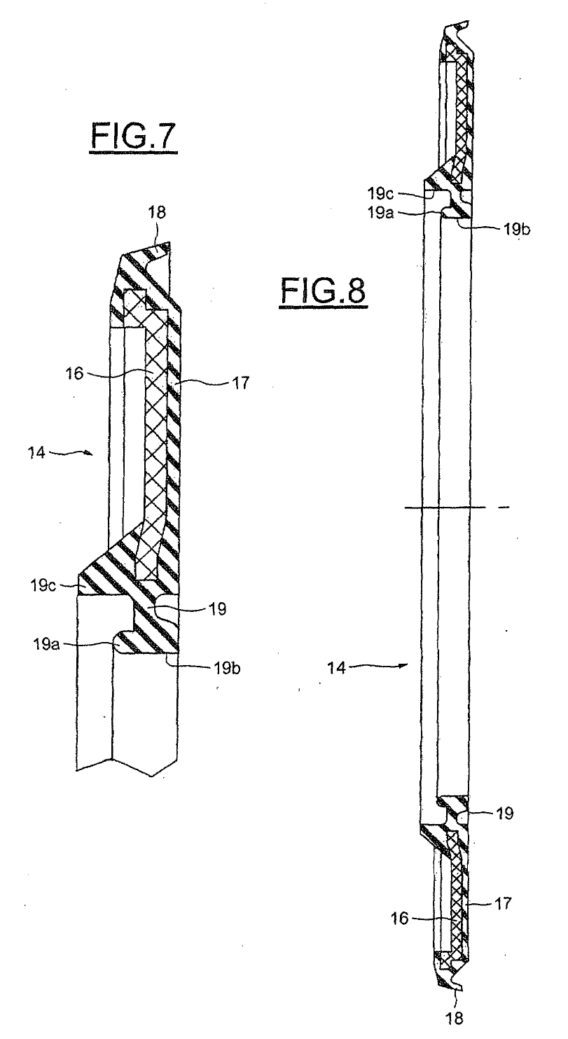

FIG. 7 shows a target seal comprising a metallic framework fitted into a cylindrical bearing surface of the outer rotating race and covered with two different materials, one providing the seal and the other forming the magnetic encoder for the generation of the signal.

Document JP 2004 011 827 also shows a target seal mounted on a cylindrical bearing surface of an inner rotating race, the material used to produce the active portion of the magnetic encoding ring being a synthetic material filled with ferrite with the same disadvantages as those mentioned above.

Document EP 0 375 019 shows a target seal mounted in a groove of the outer race of a rolling bearing using a magnetized framework to form a ring that is multipolar and covered with a flexible material forming a static seal with the groove of the outer race, and a dynamic friction seal with a bevel of the inner race. However, the inner race does not comprise means for anchoring an encoder seal on said race if the latter is the rotating race of the rolling bearing.

The main object of the invention is to produce a sealing device that is light, has a low production and installation cost and is provided with a phonic wheel or an encoder for the detection of the rotation of one race relative to the other.

The main object of the invention is to produce a multipurpose target rolling bearing, the target function and the sealing function being provided by a seal having both good static and good dynamic sealing characteristics.

The rolling bearing device comprises two races able to rotate relative to one another and at least one seal attached to one of the races and provided with an active portion designed to interact with an element for sensing a parameter of rotation of the active portion.

The device comprises, at least on one side of the rolling bearing, a groove made in the outer race and a groove made in the inner race. The grooves are substantially coplanar. The seal is mounted in one of the grooves of one of the races and interacts with at least a portion of the other groove of the other race in order to provide a dynamic seal.

It is thus possible to combine a rolling bearing of the standard type whose races are provided with lateral grooves and an element forming both a static seal with one of the races and a dynamic seal with the other race and an encoder of the magnetic type. The rolling bearing is therefore particularly economical because of its production in very long runs. The encoding and sealing element has a space requirement that is substantially identical to that of only a seal and a weight that is also relatively low.

“Static seal” means the seal produced between two parts with no relative movement, and “dynamic seal” means a seal between two parts having a relative movement.

In one embodiment, the seal comprises a sealing portion formed in a material different from the material of the active portion. The active portion forms an encoder.

In one embodiment, the seal is attached to the outer race. The seal may have a relative movement relative to the inner race. Alternatively, the seal may be attached to the inner race. The seal may have a relative movement relative to the outer race.

The seal may comprise a deflection portion in order to provide a recirculation of lubricant inside the rolling bearing.

Advantageously, the seal comprises a lip in contact with at least a portion of the groove of the other race and/or at least a portion forming a narrow passageway with a portion of the groove of the other race.

In one embodiment of the invention, the seal comprises a framework forming the active portion, covered with a flexible material providing the seal, said framework providing the rigidity of the seal.

In one embodiment, the active portion is magnetized.

In another embodiment, the active portion is magnetizable.

In one embodiment, the active portion is ferromagnetic.

In one embodiment, the active portion comprises a matrix of synthetic material filled with a powder of magnetized or magnetizable material.

The matrix may comprise a thermoplastic material having a softening temperature greater than 180°.

The matrix may comprise a material chosen from the group comprising polyamide, polyimide, polyethylene-ether-sulfone.

The device may comprise two grooves made in the outer race on one side and, on the other, rolling elements and two grooves made in the inner race on one side and, on the other, rolling elements, the groove of the inner race and the groove of the outer race placed on the same side being substantially coplanar, the device comprising two seals, each mounted in one of the grooves of one of the sides and interacting with the other groove of the other race on the same side.

The invention also relates to a rotating machine comprising a rolling bearing device placed between a casing and a rotating part. The device may be of the type described above.

This provides a rotating machine, for example an alternator or an electric motor, fitted with a particularly economical target rolling bearing, while having the desired mechanical and sealing features, the same sealing element serving as a seal and as a magnetic encoder.

The present invention will be better understood on reading the detailed description of some embodiments taken as nonlimiting examples and illustrated by the appended drawings in which:

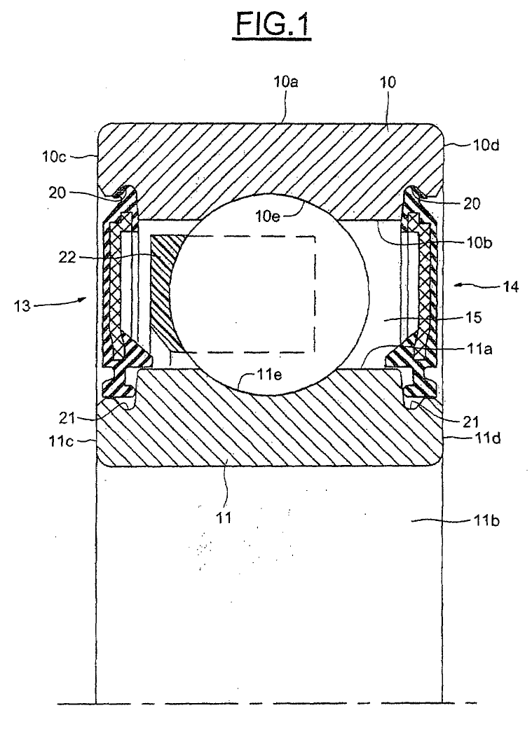

FIG. 1 is a half-view in axial section of a rolling bearing according to one embodiment;

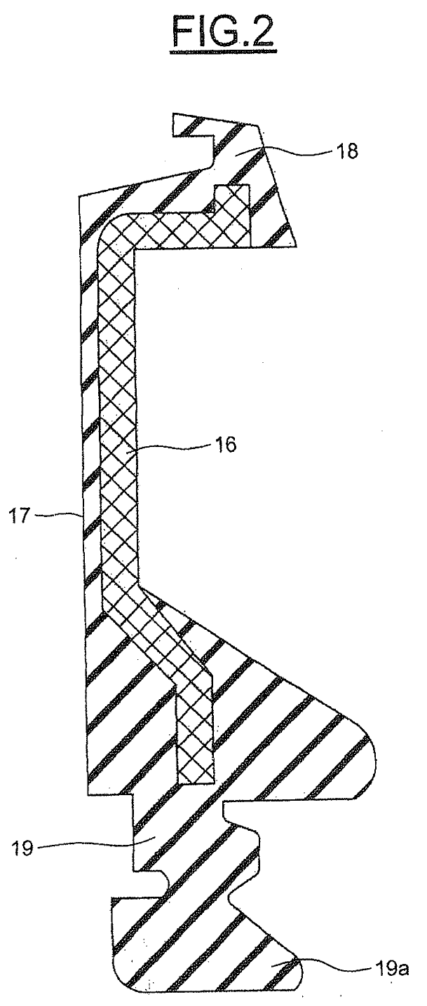

FIGS. 2 to 5 are partial half-views in axial section of different embodiments of sealing elements;

FIG. 6 is a half-view in axial section of a rolling bearing according to another embodiment;

FIG. 7 is a partial half-view in axial section of the sealing element of the rolling bearing of FIG. 6;

FIG. 8 is a view in axial section of the right sealing element of the rolling bearing of FIG. 6;

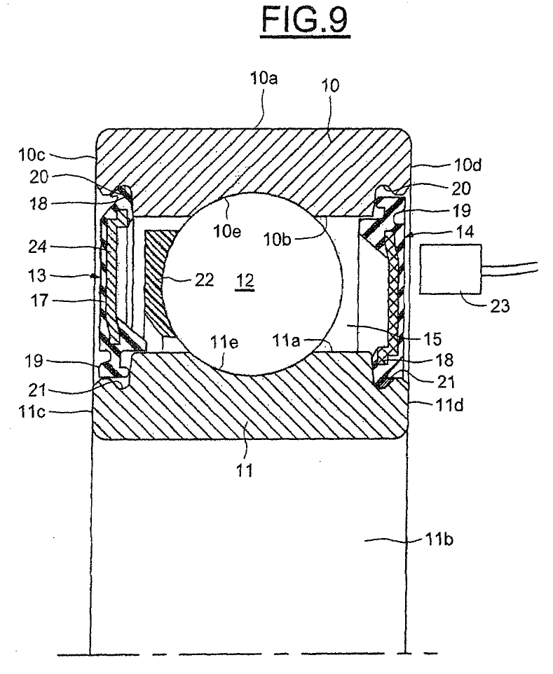

FIG. 9 is a half-view in axial section of a rolling bearing according to another embodiment;

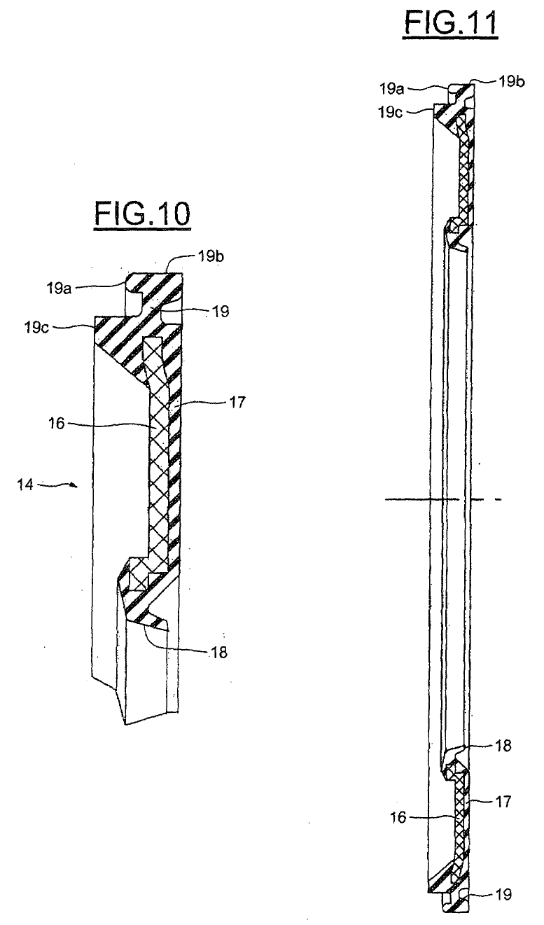

FIG. 10 is a half-view in axial section of the right sealing element of the rolling bearing of FIG. 9;

FIG. 11 is a view in axial section of the right sealing element of the rolling bearing of FIG. 9;

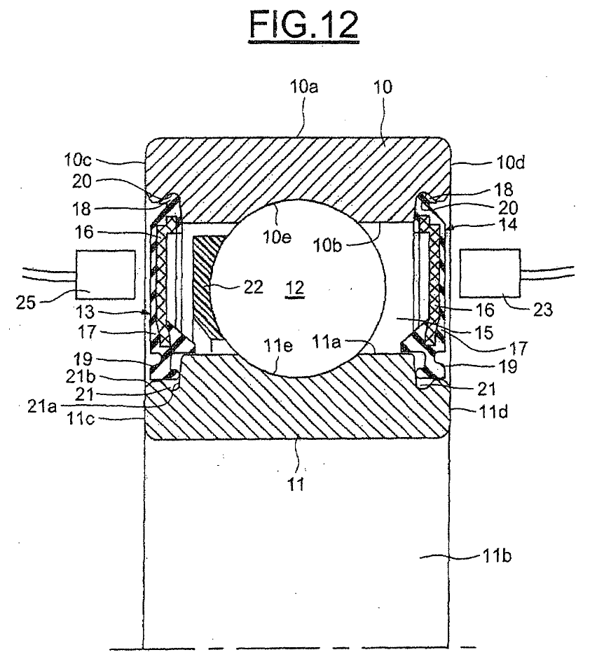

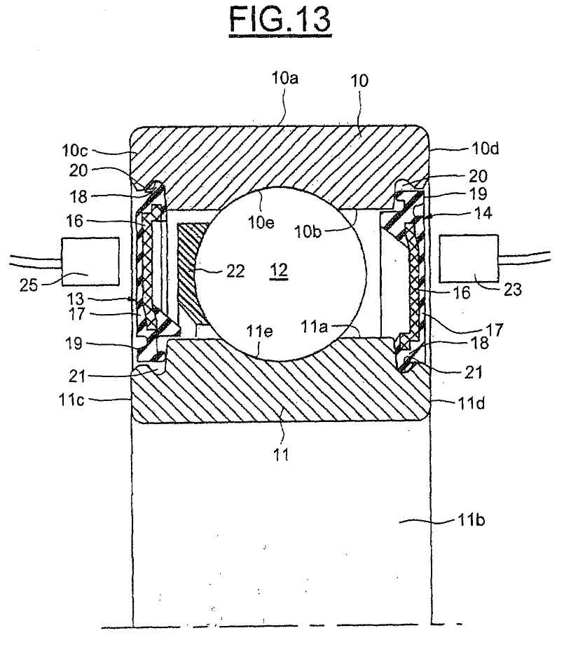

FIG. 12 is a half-view in axial section of a rolling bearing according to another embodiment;

FIG. 13 is a half-view in axial section of a rolling bearing according to another embodiment.

As illustrated in FIG. 1, a rolling bearing comprises an outer race 10, an inner race 11, and a plurality of rolling elements 12, here balls, interposed between the races 10 and 11. On each of the opposite sides of the rolling bearing, a sealing device 13, 14 of annular shape is provided in order to close off the intermediate space between the races 10 and 11.

The outer race 10 comprises an axial outer surface 10a, a bore 10b, two radial front faces 10c and 10d, a deep-grooved raceway 10e formed substantially in the middle of the bore 10b and in contact with the rolling elements 12, and two grooves 20 formed radially toward the outside from the bore 10b close to the front surfaces 10c and 10d.

Similarly, the inner race 11 comprises a bore 11b, an outer surface 11a, two radial front surfaces 11c and 11d, a deep-grooved raceway 11e formed substantially in the middle of the outer axial surface 11a and in contact with the rolling elements 12 and two annular grooves 21 formed at the ends of the axial surface 11a, close to the front surfaces 11c and 11d. The grooves 21 are placed axially substantially at the same level as the grooves 20. The rolling elements 7 are kept evenly circumferentially spaced by a cage 22.

As illustrated in FIG. 2, each sealing device 13, 14 comprises an insert 16 in the shape of a relatively rigid annular disk, on which is overmolded or vulcanized a packing 17 comprising rubber or another elastomer material. The packing 17 forms two opposite peripheral seal portions 18 and 19, applying respectively a static seal with the rotating race 10 and a dynamic seal with the nonrotating race 11. The peripheral portion 18 is inserted by force into the annular groove 20 of the rotating race 10 in order to attach the sealing device 13, 14 to said rotating race 10. The inner end portion 19 forms at least one lip 19a that provides a friction seal or a labyrinth with the nonrotating race 11.

The insert 16 may comprise a matrix of thermoplastic material filled with a powder of magnetized or magnetizable material, preferably a ferrite. The thermoplastic matrix has, preferably, a softening temperature greater than 180° C. The thermoplastic matrix may, for example, be made of polyamide (nylon 66), polyethylene, or else of polyethylene-ether-sulfone.

Thanks to these features, the insert 16, in addition to the reinforcement and mechanical rigidity of the sealing device, provides the phonic wheel function or encoding wheel function for a device for sensing rotation, associated with the rolling bearing and designed to detect the relative rotation between the races 10 and 11.

The sealing device 13, 14 is attached to the rotating race of the rolling bearing in order to be rotated with said rotating race 10, and operates both as an annular encoder and as a seal.

Before or after the overmolding or the vulcanization of the packing 17, the insert 16 is magnetized in a polarized manner in order to form, in zones or predetermined angular sectors, a succession of north-south poles that are alternated and/or placed at a distance. The magnetic properties may be conferred on the insert 16 by means of a magnetization apparatus which provides the permanent magnetization of the ferrites in predetermined zones with the desired polar orientation.

Once the sealing device 13, 14 is mounted on the rolling bearing, the encoder seal is assigned operationally to an associated sensor such as a magnet-sensitive sensor 23 mounted on another part.

During the rotation of the rotating race, the magnetic flux reaching the sensor varies as the magnetized zones of the insert 16 pass before said sensor, which can then supply electric pulses representative of the data of rotation of the rotating race, particularly the position, the speed, the angular acceleration, etc. The electric signals supplied by the sensor are transmitted to an electronic and processing unit in order to obtain information on the movement of the rotating race.

FIGS. 2 to 5 illustrate in axial section, as nonlimiting examples, four shapes that the insert 16 and the elastic packing 17 may take, depending on the geometry of the races on which the sealing device 13, 14 is to be mounted and on the operating conditions of the races 10, 11. The insert 16 may have in cross section bends and folds intended to give it rigidity.

In the embodiment illustrated in FIG. 2, the insert 16 comprises a radial portion extending toward the peripheral portion 18 via an axial portion and a short radial rim and extending toward the peripheral portion 19 via an oblique portion and a radial portion. The insert 16 therefore has good rigidity.

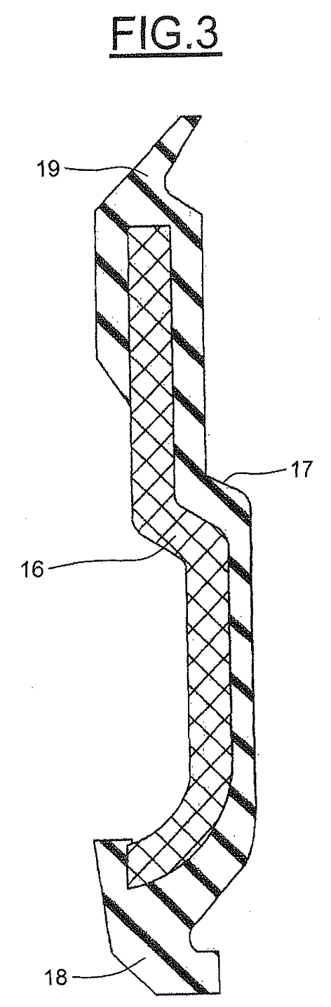

In the embodiment illustrated in FIG. 3, the peripheral portion 18 is internal and the peripheral portion 19 is external. The peripheral portion 19 comprises a simple friction lip. The insert 16 comprises a radial portion extending toward the peripheral portion 18 via a rim of toroidal shape and extending toward the peripheral portion 19 via an oblique portion and a radial portion. In the embodiment illustrated in FIG. 4, the peripheral portion 18 is external and the peripheral portion 19 is internal. The peripheral portion 19 comprises a simple friction lip. The insert 16 comprises a radial portion extending toward the peripheral portion 18 via an oblique portion and a short radial portion.

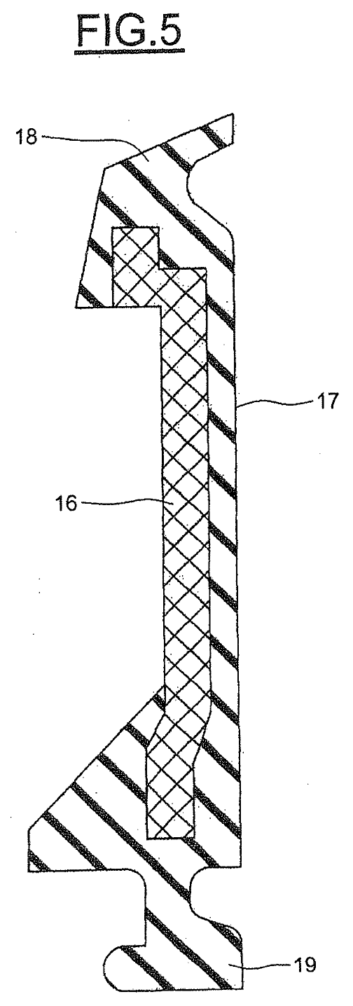

In the embodiment illustrated in FIG. 5, the peripheral portion 18 is external and the peripheral portion 19 is internal. The insert 16 comprises a radial portion extending toward the peripheral portion 18 via an axial crank and a radial rim and extending toward the peripheral portion 19 via an oblique portion and a radial portion.

In the embodiment illustrated in FIGS. 6 to 8, the dynamic sealing portion 19 of the sealing devices 13, 14 comprises a lip 19a rubbing on an inner frustoconical face 21a of the groove 21, a protuberance 19b extending axially away from the lip 19a and radially substantially at the same level in order to form a narrow passageway with a rim 21b of the groove 21, and a protuberance 19c extending axially toward the rolling elements 12 in order to form a narrow passageway with the outer surface 11b of the race 11, close to the inner frustoconical face 21a.

Advantageously, the protuberance 19c has, toward the race 10, a sloping surface, of frustoconical shape, providing for the deflection and recirculation of grease when the rolling bearing rotates. As a variant, it is possible to provide three narrow passageways or else two friction lips and one narrow passageway. This provides an extremely effective seal. Each seal is therefore installed by force in each groove 20 of the outer race and interacts with the groove 21 of the inner race situated substantially in the same radial plane as the groove 20.

A sensor 23 is placed in the vicinity of the sealing device 14 with a slight axial gap. The sealing device 14 is a target seal with a magnetic or magnetized framework and the sealing device 13 has an ordinary framework 24, for example made of steel sheet.

The embodiment illustrated in FIGS. 9 to 11 differs from the preceding one in that the rotating race is the inner race 11 and the nonrotating race is the outer race 10. The raceway 10e is made from the bore 10b and the raceway 11e is made from the outer surface 11. The sealing device 14 forming the encoder seal is installed by force in the groove 21 of the inner race 11 and the conventional sealing device 13 is installed by force in the groove 20 of the outer race 10. In other words, the sealing devices 13 and 14 are mounted top-to-toe, the encoder seal 14 being rotated by the inner rotating race 11, said encoder seal interacting also with the groove 20 of the outer race 10 in order to provide the dynamic seal, said groove 20 being substantially situated in the same radial plane as the groove 21 of the inner race 11 in which the encoder seal 14 is mounted.

The embodiment illustrated in FIG. 12 differs from the one illustrated in FIGS. 9 to 11 in that the two sealing devices 13 and 14 are target seals each with a magnetic or magnetized framework. The sealing devices 13 and 14 are mounted in the grooves 20 of the race 10. A sensor 25 is also placed in the vicinity of the sealing device 13 with a slight axial gap. This provides a redundancy offering great security.

The embodiment illustrated in FIG. 13 differs from the previous one in that the races 10 and 11 are both rotating and capable of having different speeds. The two sealing devices 13 and 14 are target seals each with a magnetic or magnetized framework. The sealing device 14 is installed by force in the groove 21 of the inner race 11 and the sealing device 13 is installed by force in the groove 20 of the outer race 10. It is therefore possible to detect the parameters of rotation of each race and, where necessary, deduce therefrom differential angular speed measurements.

The invention is not limited to the embodiments that are described and illustrated and that are considered to be examples of the sealing device and of the rolling bearing.

Quite the contrary, the invention is capable of being modified in relation to the shape, the dimension and the disposition of the elements, the details of construction and the materials used. For example, the peripheral sealing portions 18, 19 may be formed without distinction on the inner or outer peripheral edge of the sealing device depending on whether they are intended for a rolling bearing with a fixed outer race and with a rotating inner race or vice versa.

Naturally, the side of the rolling bearing comprising no sealing device 13, 14 performing the function of the encoder may either comprise no seal if this side of the rolling bearing is situated in a space sufficiently protected from pollution, or comprise a conventional, nonmagnetized seal, where necessary of the metal framework type.

It is also possible to fit the rolling bearing with a second sealing device identical to the first, if it is desired to obtain, for security, redundant information on a rolling bearing in which it is always the same race that is fixed and the same race that is rotating, or else in which it is desired to detect the rotation of the rotating race in a rolling bearing where, depending on the time, it is not the same race that rotates.

It is therefore possible to provide one sealing device attached to the outer race and the other sealing device attached to the inner race. The races may also both rotate at the same time with a differential speed that it is desired to determine.

It is therefore possible, in very economic conditions, to transform a conventional rolling bearing, chosen for example from the standard ISO range of rigid rolling bearings with a row of balls, into a target rolling bearing according to requirements. It is sufficient to mount on a conventional rolling bearing an appropriate target seal which, on the one hand, will continue to provide, via its structure, an effective seal, and, on the other hand, will allow the user, by placing opposite the target rolling bearing thus formed a magnet-sensitive sensor, to detect the rotation of the seal and to measure the parameters of rotation.

Although the illustrated examples relate to magnetized encoder seals, the rolling bearing may comprise an encoder seal with a framework that is not magnetized but made of a magnetic material such as steel, said framework comprising local variations of geometry, for example openings, reliefs, corrugations, capable of generating, with an appropriate sensor, a periodic signal representative of the parameters of rotation of the seal.

1. A rolling bearing device comprising two races able to rotate relative to one another and at least one seal attached to one of the races and provided with an active portion designed to interact with a sensor element to detect a parameter of rotation of the active portion, characterized in that it comprises, at least on one side of the rolling bearing, a groove made in the outer race and a groove made in the inner race, said grooves being substantially coplanar, the seal being mounted in one of the grooves of one of the races and interacting with at least a portion of the other groove of the other race in order to provide a dynamic seal.

2. The device as claimed in claim 1, wherein the seal comprises a sealing portion formed in a material different from the material of the active portion.

3. The device as claimed in claim 1, wherein the seal is attached to the outer race.

4. The device as claimed in claim 1, wherein the seal is attached to the inner race.

5. The device as claimed in claim 1, wherein the seal comprises a deflection portion in order to provide a recirculation of lubricant.

6. The device as claimed in claim 1, wherein the seal comprises a lip in contact with at least a portion of the groove of the other race and/or at least a portion forming a narrow passageway with a portion of the groove of the other race.

7. The device as claimed in claim 1, wherein the seal comprises a framework forming the active portion, covered with a flexible material providing the seal, said framework providing the rigidity of the device.

8. The device as claimed in claim 1, wherein the active portion is magnetized.

9. The device as claimed in claim 1, wherein the active portion is magnetizable.

10. The device as claimed in claim 1, wherein the active portion is ferromagnetic.

11. The device as claimed in claim 1, wherein the active portion comprises a matrix of synthetic material filled with a powder of magnetized or magnetizable material.

12. The device as claimed in claim 11, wherein the matrix comprises a thermoplastic material having a softening temperature greater than 180° C.

13. The device as claimed in claim 11, wherein the matrix comprises a material chosen from the group comprising: polyamide, polyimide, polyethylene-ether-sulfone.

14. The device as claimed in claim 1, further comprising two grooves made in the outer race on one side and, on the other, rolling elements and two grooves made in the inner race on one side and, on the other, rolling elements, the groove of the inner race and the groove of the outer race placed on the same side being substantially coplanar, the device comprising two seals, each mounted in one of the grooves of one of the sides and interacting with the other groove of the other race on the same side.

15. A rotating machine comprising a device as claimed in claim 1, placed between a fixed support and a rotating part.
